(19) United States
(12) Patent Application Publication
(10) Pub. No.: US 2026/0336588 A1
(43) Pub. Date: Oct. 29, 2026

(54) MULTI-CHANNEL BRAKE MODULATOR WITH REDUNDANCY FUNCTION

(71) Applicant: ZF CV Systems Global GmbH, Bern (CH)

(72) Inventors: Julian Van Thiel, Grossburgwedel (DE); Robert Otremba, Ronnenberg (DE)

(21) Appl. No.: 19/698,696

(22) Filed: Jun. 4, 2026

Related U.S. Application Data
(63) Continuation of application No. PCT/EP2024/083573, filed on Nov. 26, 2024.

(30) Foreign Application Priority Data
Dec. 11, 2023 (DE) 10 2023 134 547.8

(51) Int. Cl. B60T 13/68; B60T 7/12; B60T 13/74

(52) U.S. Cl. CPC B60T 13/683; B60T 7/12; B60T 13/74; B60T 2270/402; B60T 2270/413

(57) ABSTRACT

An electropneumatic multi-channel brake pressure modulator is for a utility vehicle. A first electropneumatic pilot control unit is configured to provide a first control pressure. A second electropneumatic pilot control unit is configured to provide a second control pressure. A first main valve arrangement is configured to provide a first brake pressure. A second main valve arrangement is configured to provide a second brake pressure. A first connection and a second connection are free of selectively switchable elements. The multi-channel brake pressure modulator has a redundancy circuit for providing a first pressure of a first channel as control pressure for the second main valve arrangement and/or for providing a second pressure of a second channel as control pressure for the first main valve arrangement. A brake system includes the electropneumatic multi-channel brake pressure modulator. A utility vehicle has the brake system.

### CROSS-REFERENCE TO RELATED APPLICATIONS

This application is a continuation application of international patent application PCT/EP2024/083573, filed Nov. 26, 2024, designating the United States and claiming priority from German application 10 2023 134 547.8, filed Dec. 11, 2023, and the entire content of both applications is incorporated herein by reference.

### TECHNICAL FIELD

The disclosure concerns an electropneumatic multi-channel brake pressure modulator for a utility vehicle, having at least one first reservoir port for connecting a first compressed air reservoir for providing reservoir pressure at the first reservoir port, at least one first channel and one second channel, wherein the first channel includes a first working port, a first electropneumatic pilot control unit and a first main valve arrangement, and wherein the second channel includes a second working port, a second electropneumatic pilot control unit and a second main valve arrangement. The electropneumatic multi-channel brake modulator furthermore includes a first electronic control unit for controlling the first electropneumatic pilot control unit, and a second electronic control unit for controlling the second electropneumatic pilot control unit, wherein the first electropneumatic pilot control unit is configured to receive reservoir pressure from the reservoir port and to provide a first control pressure as a function of first control signals which are provided by the first electronic control unit at the first electropneumatic pilot control unit, and wherein the second electropneumatic pilot control unit is configured to receive reservoir pressure from the reservoir port and to provide a second control pressure as a function of second control signals which are provided by the second electronic control unit at the second electropneumatic pilot control unit. The first main valve arrangement is configured to receive a control pressure and provide a volume-amplified first brake pressure, corresponding to the received control pressure, at the first working port, and the second main valve arrangement is configured to receive a control pressure and to provide a volume-amplified second brake pressure, corresponding to the received control pressure, at the second working port.

### BACKGROUND

Vehicles, in particular utility vehicles, are usually equipped with pneumatic brake systems. In such pneumatic brake systems, electropneumatic brake pressure modulators of the above-mentioned type are used. Pneumatic brake systems for motor vehicles generally have a pneumatically actuated wheel brake for each wheel of the motor vehicle. An operating medium for the wheel brakes, in particular compressed air, is provided under static pressure in a storage reservoir. Electropneumatic brake systems often include a brake signal emitter coupled to a brake pedal which can be actuated by the driver of the motor vehicle. Upon actuation of the brake pedal, the brake signal emitter generates a brake request signal. Depending on the brake request signal, a corresponding brake pressure is provided at the wheel brakes. In modern vehicles, the brake signal emitter can also work purely electronically, so that a brake request signal is output in particular by a control unit or similar. This allows a partially or fully autonomous brake actuation. An electronic control unit controls the brake pressure modulator as a function of the brake requests. To simplify mounting, an electronic control unit of the electropneumatic brake pressure modulator may form the control unit which provides the electronic brake request signal or brake request signal. In order to be able to control the driving dynamics of the utility vehicle appropriately, modern vehicles generally have a plurality of brake circuits which can be controlled independently of one another. For example, front wheel brakes may be assigned to a first brake circuit, while rear wheel brakes of the utility vehicle are assigned to a second brake circuit. Furthermore, alternatively or additionally, the brake circuits may also be assigned to different sides of the vehicle. To simplify mounting, reduce weight and/or reduce costs, it is advantageous if a brake modulator has a plurality of channels which can be assigned to the different brake circuits of a brake system. For example, a single such multi-channel brake modulator can provide both a brake pressure for a front axle brake circuit and also a brake pressure for a rear axle brake circuit.

In particular in view of the increasing automation of vehicles, it is important that the vehicle can still be brought safely to a standstill even in the event of a fault. Advantageously, despite the presence of an electrical fault, the vehicle can still be operated, so as to reduce downtime.

Against this background, EP 4 186 760 A1 discloses a redundant control system for controlling a first pressure for a first brake actuator and a second pressure for a second brake actuator of a vehicle. The system includes a first electronic control unit which controls a first valve arrangement configured to provide a first pressure; a second electronic control unit which controls a second valve arrangement configured to provide a second pressure; a first switching valve which is controlled by the first electronic control unit and configured to provide the second delivery pressure by selection of either the first pressure or the second pressure; a second switching valve which is controlled by the second electronic control unit and configured to provide the first delivery pressure by selection of either the first pressure or the second pressure.

EP 3 174 769 B1 discloses a brake pressure modulator of an electropneumatic brake system of a utility vehicle, wherein the brake pressure modulator has at least two pressure-regulating circuits combined into one unit, wherein the pressure-regulating circuits are each assigned to a brake circuit of a vehicle axle, wherein each of the pressure-regulating circuits is or can be connected to its own compressed-air storage reservoir, wherein at least one redundancy control pressure path, at least one venting path and a common control electronics for the pressure-regulating circuits are present, and wherein the pressure-regulating circuits can be regulated independently of one another via the control electronics, wherein each pressure-regulating circuit has its own venting path, and wherein at least one of the pressure-regulating circuits has its own redundancy control pressure path, and at least one other of the pressure-regulating circuits has a device for forced venting via the assigned venting path in the event of a failure.

### SUMMARY

It is an object of the disclosure to increase the safety of vehicles, to facilitate the integration of an electropneumatic brake pressure modulator into a brake system or a vehicle, to improve the reliability, to improve the reaction time and/or to reduce the overall cost of an electropneumatic brake pressure modulator.

In a first aspect, the disclosure achieves this object via an electropneumatic multi-channel brake pressure modulator according to various embodiments of the disclosure. In particular, in an electropneumatic multi-channel brake pressure modulator for a utility vehicle of the type cited initially, the disclosure achieves the above-mentioned object, in that a first connection, which connects the first pilot control unit to the first main valve arrangement for providing the first control pressure, is free of selectively switchable elements; in that a second connection, which connects the second pilot control unit to the second main valve arrangement for providing the second control pressure, is free of selectively switchable elements; and in that the multi-channel brake pressure modulator furthermore includes a redundancy circuit for providing a first pressure of the first channel as control pressure for the second main valve arrangement for output of the second brake pressure in the redundancy case, and/or for providing a second pressure of the second channel as control pressure for the first main valve arrangement for output of the first brake pressure in the redundancy case.

A redundancy case is present in particular when the first electronic control unit or the second electronic control unit has a fault and/or fails. Without the presence of a redundancy level, in the event of a fault, it would not be possible to output a brake pressure at the first working port if the fault concerns the first electronic control unit, or to output a brake pressure at the second working port if the fault concerns the second electronic control unit. This is the starting point of the disclosure, which makes it possible that, in the redundancy case, a first pressure of the first channel can be provided as control pressure for the second main valve arrangement, and/or that, in the redundancy case, a second pressure of the second channel can be provided as control pressure for the first main valve arrangement. According to various embodiments, the first electronic control unit and the second electronic control unit are control units which are physically separate from one another. According to various embodiments, the electronic control unit and the second electronic control unit have energy supplies which are independent of one another. However, it may also be provided that the first electronic control unit and the second electronic control unit are arranged on the same circuit board. For example, the control units may be formed by two processors of a circuit board or be divided only at the software level.

In a multi-channel brake pressure modulator having at least a first channel and a second channel, the two channels with their respective electronic control unit may form a redundancy level for one another. It is however desirable to avoid disadvantages for normal operation (the case without failure of an electronic control unit), since this normal operation will be present in the vast majority of cases. The first connection and the second connection are each free of selectively switchable elements. Such connections are also referred to herein as non-switching connections. The first pilot control unit is thus connected in a non-switching manner to the first main valve arrangement and the second pilot control unit is connected in a non-switching manner to the second main valve arrangement. The disclosure is based on the finding that the dynamics and/or robustness of the multi-channel brake modulator can be improved if the first pilot control unit is connected to the first main valve arrangement in a non-switching manner and if the second pilot control unit is connected to the second main valve arrangement in a non-switching manner. In normal operation, the first pilot control unit provides the control pressure for the first main valve arrangement. A non-switching first connection can allow a particularly high dynamic in provision of the first control pressure, since no switching processes of selectively switchable components delay this provision. Furthermore, non-switching connections often have a small volume. In response to a brake request therefore, a corresponding brake pressure can be provided as quickly as possible. This applies similarly to the non-switching connection between the second pilot control unit and the second main valve arrangement. Furthermore, a non-switching connection is robust. The absence of a switchable element also eliminates a potential source of error which prevents the provision of control pressure from the first (second) pilot control unit to the first (second) main valve arrangement. Furthermore, a non-switching connection can be made particularly compact and/or cost-effective. It should be understood that a non-switching connection can also include passive or non-switchable elements. For example, a non-switching connection can also contain a check valve. Flow through the non-switching connection may then be possible in one direction only, for example.

According to various embodiments, a non-switching connection is a sustained (fluidic) or permanent connection. It should be understood that a non-switching connection can allow flow branching and/or flow divisions. According to various embodiments, the first pilot control unit and the first main valve arrangement are directly connected together, and/or the first pilot control unit and the second main valve arrangement are directly connected together. A direct connection includes exclusively flow-conductive components, such as hoses, pipes and distributors, but not valves. The advantageous non-switching connection also allows a passive redundancy. Such a passive redundancy can be achieved without a dedicated switching valve and is thus more fail-safe and cost-effective than variants with a switching valve between the first (or second) pilot control unit and the first (or second) main valve arrangement.

The electropneumatic multi-channel brake pressure modulator includes at least two channels, but may also preferably have three or more channels.

In a first embodiment of the electropneumatic multi-channel brake pressure modulator, the first pilot control unit of the first channel has a first inlet valve for output of the first control pressure and a first outlet valve, and the second pilot control unit of the second channel has a second inlet valve for output of the second control pressure and a second outlet valve. The first inlet valve and/or the second inlet valve is preferably configured as a switchable 2/2-way valve, particularly preferably as an electronically switchable 2/2-way valve. The first outlet valve and/or the second outlet valve is preferably configured as a switchable 2/2-way valve, particularly preferably as an electronically switchable 2/2-way valve. The first inlet valve, the second inlet valve, the first outlet valve and/or the second outlet valve can preferably be configured as solenoid valves. The first inlet valve and/or the second inlet valve may allow a modulation of the pressure, in particular as a function of control signals of the first and/or second electronic control unit.

According to various embodiments, the redundancy circuit connects the first pilot control unit of the first channel at least indirectly to the second main valve arrangement for providing the first control pressure at the second main valve arrangement, and/or connects the second pilot control unit of the second channel at least indirectly to the first main valve arrangement for providing the second control pressure at the first main valve arrangement. Advantageously, in this way, the first control pressure provided by the first pilot control unit of the first channel can function as control pressure of the second main valve arrangement, and/or the second control pressure provided by the second pilot control unit of the second channel can function as control pressure of the first main valve arrangement. Thus, in the redundancy case, the pilot control unit of one channel can also be used as a pilot control unit of the respective other channel or of another channel. An at least indirect connection may be a direct connection. An indirect connection however also includes connections in which a further valve is arranged between the pilot control unit and the main valve arrangement.

In a variant, the first channel has a first control line which connects the first pilot control unit to the first main valve arrangement, and the second channel has a second control line which connects the second pilot control unit to the second main valve arrangement, wherein the redundancy circuit connects the first control line to the second control line. The connection of the control lines by the redundancy circuit allows a particularly simple use of the control pressure in the redundancy case. The control pressure of a channel can then also be used in the redundancy case as a control pressure for a further channel. Since the redundancy circuit connects only control lines, the volume flow to be conducted is comparatively small and the redundancy circuit can be configured with a small flow cross-section. This allows a particularly compact construction and/or high dynamic.

According to various embodiments, the redundancy circuit has a first redundancy valve, wherein the redundancy circuit indirectly connects the first control line to the second control line via the redundancy valve. The redundancy valve is preferably switchable in order to interrupt a connection of the control lines. Thus, the connection of the first control line and the second control line can be interrupted in a normal state. In a redundancy switching state however, the first control line can be fluidically connected to the second control line via the redundancy valve. The redundancy valve can thus limit a control volume during normal operation. Furthermore, the redundancy valve may separate at least the first channel and the second channel from one another and thus prevent an undesired mutual influencing during normal operation. The first redundancy valve is preferably pretensioned into an open state, in which it allows a fluidic connection of the first control line and the second control line. Thus it can be ensured that the redundancy valve opens automatically in the absence of an (electronic and/or pneumatic) control signal. The redundancy valve is preferably an electronically controllable solenoid valve, which particularly preferably allows a fluidic connection of the first control line and the second control line in the de-energized state.

According to various embodiments, the redundancy circuit furthermore includes a second redundancy valve between the first control line and the second control line. The second redundancy valve is preferably configured substantially similarly, particularly preferably identically, to the first redundancy valve. According to various embodiments, the redundancy circuit includes one redundancy valve per channel of the multi-channel brake pressure modulator.

In various embodiments, the first redundancy valve is an electronically switchable redundancy valve and the second redundancy valve is an electronically switchable redundancy valve, wherein the first electronic control unit is configured to control the first redundancy valve, and wherein the second electronic control unit is configured to control the second redundancy valve. According to various embodiments, the first redundancy valve is an electronically switchable 2/2-way valve and/or the second redundancy valve is an electronically switchable 2/2-way valve. The actuation of the at least two redundancy valves of the redundancy circuit via different control units ensures a low fault susceptibility. Thus a functioning control unit can ensure that a control pressure of one channel is provided for the main valve arrangement of another channel only if this is also necessary. According to various embodiments, the first redundancy valve and the second redundancy valve are open in the de-energized state and allow a fluidic connection of the first control line and the second control line. In the event of a fault in an electronic control unit, the redundancy valve assigned to this control unit then opens, preferably automatically. The other (fault-free) electronic control unit can then selectively open or close its assigned redundancy valve and thus, if required, also provide the control pressure of its channel as control pressure of the main valve arrangement of the faulty channel.

In various embodiments, the first outlet valve of the first pilot control unit has a first outlet valve inlet port which is connected to a first inlet valve working port of the first inlet valve, and a first outlet valve outlet port; the second outlet valve of the second pilot control unit has a second outlet valve inlet port which is connected to a second inlet valve working port of the second inlet valve, and a second outlet valve outlet port; and the redundancy circuit connects the first outlet valve outlet port of the first outlet valve of the first channel to the second outlet valve outlet port of the second outlet valve of the second channel. The first outlet valve is preferably provided for venting the first inlet valve working port. Similarly, the second outlet valve is preferably provided for venting the second inlet valve working port of the second inlet valve. In the preferred embodiment, the outlet valves are advantageously used to provide the redundancy function. Thus for example, a first control pressure provided by the first inlet valve at the first inlet valve working port can be provided, via the first outlet valve, the redundancy circuit and the second outlet valve, at the second inlet valve working port of the second inlet valve. Because of the non-switching connection of the second pilot control unit to the second main valve arrangement, in this example the first control pressure can be used, via the redundancy circuit, as control pressure for the second main valve arrangement.

According to various embodiments, the electropneumatic multi-channel brake pressure modulator further includes a switchable venting valve having a venting position, wherein the venting valve is connected to the first outlet valve outlet port of the first outlet valve and, in the venting position, connects the first outlet valve outlet port to a vent of the electropneumatic multi-channel brake modulator, and/or wherein the venting valve is connected to the second outlet valve outlet port of the second outlet valve, and in the venting position, connects the second outlet valve outlet port to a vent of the electropneumatic multi-channel brake modulator. The first outlet valve and/or the second outlet valve can then advantageously be used both for providing a redundancy and also for venting the respective main valve arrangement. The venting valve is then preferably configured to switch between these two functions.

In further embodiments, the electropneumatic multi-channel brake pressure modulator further includes a redundancy port for providing a redundancy pressure. Thus, a pneumatic redundancy can also be provided at the electropneumatic multi-channel brake modulator. This for example, a brake pressure can be provided at the multi-channel brake modulator via a foot brake pedal.

According to various embodiments, the redundancy pressure can be output as a control pressure at the first main valve arrangement if the first electronic control unit has a fault, and/or can be output at the second main valve arrangement if the second electronic control unit has a fault. According to various embodiments, the multi-channel brake modulator is configured to output a brake pressure based on the redundancy pressure only if both the first electronic control unit and also the second electronic control unit have a fault.

In a variant, the electropneumatic multi-channel brake pressure modulator further includes a first electronically controllable holding valve and a second electronically controllable holding valve, wherein the first electronically controllable holding valve and the second electronically controllable holding valve connect the redundancy port to the redundancy circuit, wherein preferably the first electronic control unit is provided for controlling the first electronically controllable holding valve, and the second electronic control unit is provided for controlling the second electronically controllable holding valve. According to various embodiments, starting from the redundancy connection, the venting valve is arranged between the first holding valve and the second holding valve or vice versa. According to various embodiments, the two holding valves are pretensioned into an open switching state. By providing two or more holding valves, at least one of which is controllable by each of the electronic control units, it can be ensured that a still functional control unit can control the provision of the redundancy pressure.

In a further embodiment, the redundancy circuit connects a first brake pressure port of the first main valve arrangement at least indirectly to a second control port of the second main valve arrangement, in order to be able to provide the first brake pressure as control pressure at the second main valve arrangement, wherein the redundancy circuit connects the first brake pressure port, preferably via a second outlet valve of the second channel, to the second control port. Alternatively or additionally, the redundancy circuit may connect a second brake pressure port of the second main valve arrangement at least indirectly to a first control port of the first main valve arrangement, in order to be able to provide the second brake pressure as control pressure at the first main valve arrangement, wherein the redundancy circuit connects the second brake pressure port, preferably via a first outlet valve of the first channel, to the first control port. In this variant, the brake pressure provided at a channel with a functional electronic control unit can then be used as control pressure for a further channel, the electronic control unit of which has a fault.

In a second aspect, the disclosure achieves the object by a brake system, in particular an electronically controllable pneumatic brake system. According to an embodiment, the brake system has a first brake circuit, a second brake circuit and an electropneumatic multi-channel brake modulator according to the first aspect of the disclosure, wherein the first working port of the first channel of the multi-channel brake modulator is connected to the first brake circuit for providing the first brake pressure, and wherein the second working port of the second channel of the multi-channel brake modulator is connected to the second brake circuit for providing the second brake pressure.

The brake system can preferably have a first voltage supply for supplying the first electronic control unit with electrical energy, and a second voltage supply for supplying the second electronic control unit with electrical energy. The first voltage supply and the second voltage supply can preferably be operated independently of one another. Thus, a fault in the first voltage supply preferably has no influence on the second voltage supply. The provision of two voltage supplies can further increase an operating safety, since an electronically controlled braking is still possible even in the event of failure of one of the two voltage supplies.

According to various embodiments, the brake system further includes an autonomous unit, a first bus system, in particular a first CAN bus, and a second bus system, in particular a second CAN bus, wherein the first electronic control unit of the multi-channel brake modulator is connected to the first bus system for providing and/or receiving signals, and wherein the second electronic control unit of the multi-channel brake modulator is connected to the second bus system for providing and/or receiving signals. The first bus system preferably connects together at least the autonomous unit and the first electronic control unit. The provision and/or reception of signals may take place from the main control unit to the first electronic control unit and/or vice versa. Similarly, the second electronic control unit is preferably connected to the autonomous unit via the second bus system. Alternatively or additionally, the first bus system and/or the second bus system can also be connected to a main control unit of the brake system via the first bus system or the second bus system. However, it can also be provided that the main control unit is an autonomous unit. The autonomous unit may be a semi-autonomous unit or a fully autonomous unit.

It should be understood that the electropneumatic multi-channel brake pressure modulator according to the first aspect of the disclosure and the brake system according to the second aspect of the disclosure have the same and similar sub-aspects.

In a third aspect, the disclosure achieves the object cited initially by a utility vehicle having a brake system according to the second aspect of the disclosure. It is to be understood that the brake system according to the second aspect of the disclosure and the utility vehicle according to the third aspect of the disclosure have the same and similar sub-aspects. In this respect, reference is made to the above description in full.

### BRIEF DESCRIPTION OF DRAWINGS

The invention will now be described with reference to the drawings wherein:

FIG. 1 shows an electronically controllable pneumatic brake system with an electropneumatic multi-channel brake pressure modulator;

FIG. 2 is a schematic illustration of a first embodiment of the electropneumatic multi-channel brake pressure modulator;

FIG. 3 is a schematic illustration of a second embodiment of the electropneumatic multi-channel brake pressure modulator;

FIG. 4 is a schematic illustration of a third embodiment of the electropneumatic multi-channel brake pressure modulator; and,

FIG. 5 is a schematic illustration of a fourth embodiment of the electropneumatic multi-channel brake pressure modulator.

### DETAILED DESCRIPTION

In the FIGS., the common elements are usually described first below and then the differences between the different embodiments are explained. In particular, the similarities are not further emphasized and it should be understood that in principle, each of the embodiments can be combined with the further embodiments.

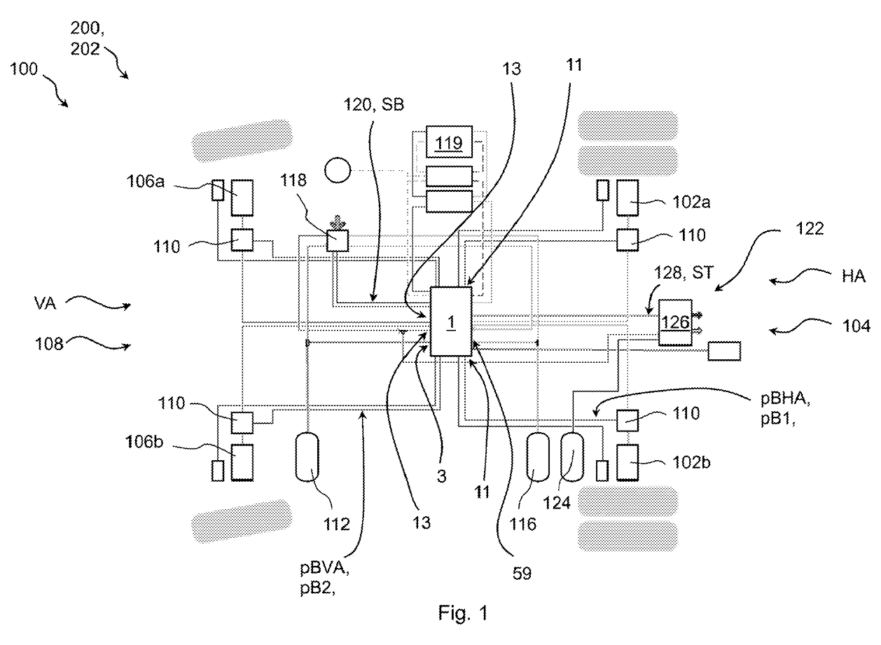

FIG. 1 illustrates an electronically controllable pneumatic brake system 100 for a vehicle 200, in particular a utility vehicle 202. The vehicle 200 has a front axle VA and a rear axle HA, wherein this disclosure also includes vehicles 200 with more than one, namely in particular two, three or more rear axles and also more than one, in particular two, three or four front axles. The electronically controllable pneumatic brake system 100 includes, at the rear axle HA, first and second rear axle brake actuators 102a, 102b which can be opened completely or partially by provision of a corresponding rear axle brake pressure pBHA, which in the present case is also called first brake pressure pB1. The first and second rear axle brake actuators 102a, 102b are here assigned to a rear axle brake circuit 104 of the brake system 100. To provide a vehicle deceleration at the front axle VA, the brake system 100 furthermore includes first and second front axle brake actuators 106a, 106b which are assigned to a front axle brake circuit 108. In a similar fashion to the rear axle brake actuators 102a, 102b, the front axle brake actuators 106a, 106b can also be opened completely or partially by provision of a brake pressure pB, namely a front axle brake pressure pBVA or second brake pressure pB2. Also, ABS valves 110 are additionally provided on the front axle VA and the rear axle, in order to implement an antilock function. The rear axle brake circuit 104 is here a first brake circuit 104 and the front axle brake circuit 108 is here a second brake circuit 108 of the utility vehicle 202. However, it may also be provided that the front axle brake circuit 108 forms or includes the first brake circuit 104, and/or that the rear axle brake circuit 104 forms or includes the second brake circuit 108.

For providing the first brake pressure pB1 and the second brake pressure pB2, the electronically controllable pneumatic brake system 100 further includes an electropneumatic multi-channel brake pressure modulator 1. The multi-channel brake pressure modulator 1 receives reservoir pressure pV from a first compressed air reservoir 112. For this purpose, a reservoir port 3 of the multi-channel brake pressure modulator 1 is pneumatically connected to the first compressed air reservoir 112. It may also be provided that the multi-channel brake pressure modulator 1, as shown in FIG. 1, is configured for connection to a second compressed air reservoir 116 of the brake system 1. However, this is purely optional and not shown in the further FIGS. for the sake of simplicity.

The electronically controllable pneumatic brake system 100 is configured here, by way of example, such that it can be operated both manually by a driver and also automatically. To this end, the vehicle 200 firstly has a brake transducer 118 in the form of an electropneumatic brake pedal. The brake transducer 118 is here connected to the multi-channel brake pressure modulator 1 via a brake signal line 120. The brake transducer 118 converts a pedal movement, initiated by a driver of the vehicle 200, into a brake signal SB which is then provided electronically at the multi-channel brake pressure modulator via the brake signal line 120. Furthermore, the brake transducer 118 also provides a pneumatic redundancy pressure pR at a redundancy port 5 of the multi-channel brake pressure modulator 1. This optional functionality will be explained in detail later. The configuration shown here is merely exemplary and the disclosure is not explicitly limited thereto. Furthermore, brake signals SB may also be provided at the multi-channel brake pressure modulator 1 by an autonomous unit 119. The autonomous unit 119 may, for example, be configured for fully autonomous control of the vehicle 200. However, it may also be provided, for example, that the autonomous unit 119 provides brake signals SB at the multi-channel brake pressure modulator 1 for realizing an emergency braking function. The autonomous unit 119 can preferably also be integrated into the multi-channel brake pressure modulator 1 and/or be realized by an electronic control unit 19, 25 of the multi-channel brake pressure modulator 1. Alternatively or additionally to an autonomous unit 119, the brake system may also include a main control unit ECU.

At the rear axle HA, the electronically controllable pneumatic brake system 100 further includes a trailer brake circuit 122, which is provided for supplying a trailer (not shown) with trailer brake pressures. The trailer brake circuit 122 includes a third compressed air reservoir 124 and an electronically controllable trailer module 126. In the embodiment shown, the trailer module 126 is connected to the multi-channel brake pressure modulator 1 via a trailer control line 128. The multi-channel brake pressure modulator 1 is here configured to provide, via the trailer control line 128, trailer control signals ST for controlling the trailer module 126.

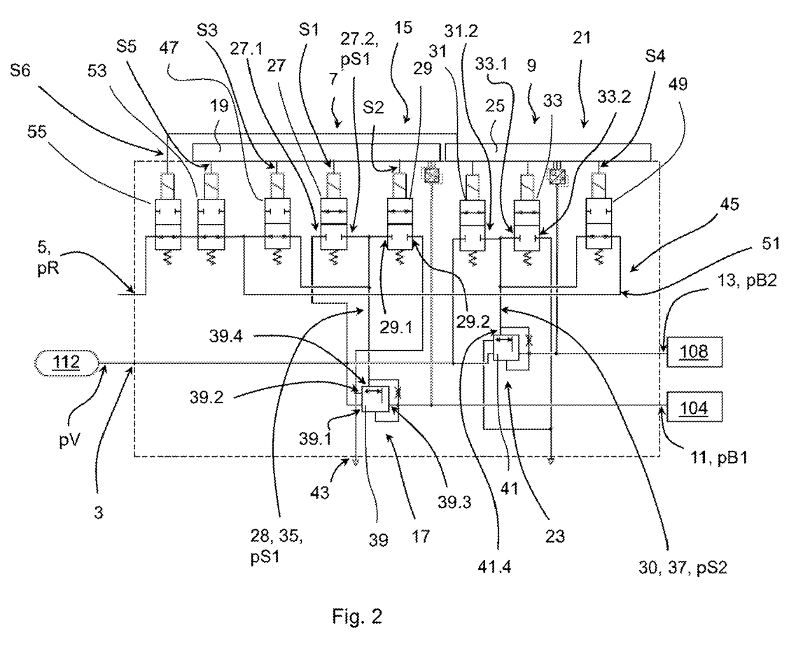

In the embodiment according to FIG. 1, the electropneumatic multi-channel brake pressure modulator 1 has four ports, wherein each of the brake actuators 102a, 102b, 106a, 106b is supplied with a brake pressure via its own port of the multi-channel brake pressure modulator 1. In this case, in the embodiment shown, the ports for the first and second rear axle brake actuators 102a, 102b are assigned to a first channel 7 of the multi-channel brake pressure modulator 1, and the first and second front axle brake actuators 106a, 106b are assigned to a second channel 9 of the multi-channel brake pressure modulator 1. However, it may also be provided that each of the brake actuators 102a, 102b, 106a, 106b is assigned to its own channel, or that the brake actuators 102a, 106a of the right side of the vehicle 200 are assigned to the first channel 7 and the brake actuators 102b, 106b of the left side of the vehicle 200 are assigned to the second channel 9. As is also shown in FIGS. 2 - 5, each channel 7, 9 may also have only a single working port 11, 13. Thus, the first channel 7 can provide the first brake pressure pB1 only at a first working port 11 for the rear axle brake circuit 104, and/or the second channel 9 can provide the second brake pressure pB2 only at a second working port 13 for the front axle brake circuit 108.

FIG. 2 now schematically shows a first preferred embodiment of the multi-channel brake pressure modulator 1. For the purpose of illustration, FIG. 2 also shows the first compressed air reservoir 112 and, schematically, the rear axle brake circuit 104 and the front axle brake circuit 108. The multi-channel brake pressure modulator 1 here has the first channel 7 and the second channel 9, wherein the first channel 7 is connected via the first working port 11 to the rear axle brake circuit 104 in order to provide the first brake pressure pB1 there. Similarly, the second channel 9 is connected via the second working port 13 to the front axle brake circuit 108 in order to provide the second brake pressure pB2 there.

The first channel 7 includes a first electropneumatic pilot control unit 15 and a first main valve arrangement 17. A first electronic control unit 19 is provided for controlling the first electropneumatic pilot control unit 15. The first electronic control unit 19 is configured to receive the brake signals SB and to control the first electropneumatic pilot control unit 15 on the basis of these signals.

In the first embodiment of the multi-channel brake pressure modulator 1, the second channel 9 is structured substantially identically to the first channel 7 and includes a second electropneumatic pilot control unit 21, a second main valve arrangement 23 and a second electronic control unit 25 for controlling the second electropneumatic pilot control unit 21. The provision of a brake pressure is therefore explained below with reference to the first channel 7, wherein the description applies substantially similarly to the second channel 9.

In normal operation of the multi-channel brake pressure modulator 1, the first electronic control unit 19 and the second electronic control unit 25 have no fault. The control units 19, 25 control their respective channel 7, 9 based on the brake signals SB, in order to provide the first brake pressure pB1 and/or the second brake pressure pB2. To provide the first brake pressure pB1, the first channel 7 receives the reservoir pressure pV. From the reservoir port 3, the reservoir pressure reaches both the first main valve arrangement 17 and also the first pilot control unit 15.

The first pilot control unit 15 includes a first inlet valve 27 and a first outlet valve 29. The second pilot control unit 21 similarly includes a second inlet valve 31 and a second outlet valve 33. The second inlet valve 31 includes, inter alia, a second inlet valve working port 31.2. The second outlet valve 33 includes a second outlet valve inlet port 33.1 and an outlet valve outlet port 33.2.

The first inlet valve 27 is configured as an electronically switchable 2/2-way valve and receives first control signals S1 from the first electronic control unit 19. In de-energized state, the first inlet valve 27 is preferably in the first switching position (shown in FIG. 2), in which a first inlet valve port 27.1 is separated from a second inlet valve port 27.2. The second inlet valve port 27.2 can also be referred to as inlet valve working port 27.2. By providing corresponding first control signals S1, the first inlet valve 27 can be switched between the switching position shown in FIG. 2 and an open switching position, in which the first inlet valve port 27.1 and the second inlet valve port 27.2 are connected to one another.

The reservoir pressure pV provided at the reservoir port 3 is also present at a first inlet valve port 27.1 of the first inlet valve 27. The first inlet valve 27 provides a first control pressure pS1 based on the first control signals S1. According to various embodiments, the first inlet valve 27 is configured to modulate the control pressure pS1. For example, the first inlet valve 27 can be switched in steps or continuously between the fully closed position (inlet valve ports 27.1, 27.2 separated) and the fully open position.

The first pilot control unit 15 is connected in a non-switching fashion to the first main valve arrangement 17. A first connection 28, which connects the first pilot control unit 15 to the first main valve arrangement 17, is free of selectively switchable elements, in particular free of switchable valves. In the embodiment shown, the first connection 28 is a direct connection without interposed valves. Via the first connection 28, the first control pressure pS1 can be provided by the first pilot control unit 15 at the first main valve arrangement 17. In the embodiment shown in FIG. 2, the second inlet valve port 27.2, at which the first control pressure pS1 is output, is connected directly and in non-switching fashion to the first main valve arrangement 17 via a first control line 35. Similarly, a second connection 30, which connects the second pilot control unit 21 to the second main valve assembly 23, is free of selectively switchable elements. In the embodiment shown, the second pilot control unit 21 of the second channel 9 or its second inlet valve 31 is directly connected via a second control line 37 to the second main valve arrangement 23, in order to provide a second control pressure pS2 there.

The first control pressure pS1 can be provided particularly reliably at the first main valve arrangement 17 by the non-switching connection. Since there is no switching between the pilot control unit 15 and the main valve unit 17, switching faults in this connection are eliminated. Furthermore, a control volume between the first main valve arrangement 17 and the first pilot control unit 15 is comparatively small, as a result of which a high dynamic can be achieved. In the embodiments shown, the first main valve arrangement 17 includes a first relay valve 39 and the second main valve arrangement similarly includes a second relay valve 41 with a second control port 41.4.

The first relay valve 39 has a first relay valve reservoir port 39.1, a first relay valve venting port 39.2, a first relay valve working port 39.3 and a first relay valve control port 39.4. The first relay valve reservoir port 39.1 is connected to the reservoir port 3 for receiving reservoir pressure pV. The first relay valve venting port 39.2 is connected to a vent 43 which preferably includes an air outlet silencer (not shown). The first relay valve working port 39.3 of the first main valve arrangement 17 of the first channel 7 is connected to the first working port 11 of the electropneumatic multi-channel brake pressure modulator 1. The first relay valve 39 outputs the first brake pressure pB1 at the first working port 11 as a function of corresponding control signals.

The first relay valve control port 39.4 is connected to the first control line 35. In normal operation, the first relay valve control port 39.4 receives the first control pressure pS1 from the first inlet valve 27 via the first control line 35. Depending on the level of the first control pressure pS1, the first relay valve 39 then outputs the first brake pressure pB1 at the first relay valve working port 39.3. The first brake pressure pB1 is output as a function of a pneumatic control signal provided at the first relay valve control port 39.4 (in normal operation, the first control pressure pS1) without electrical control signals, that is, even when the first electronic control unit 19 is de-energized and/or has a fault.

The first relay valve 39 can also be used for venting the first working port 11. Thus, the rear axle brake actuators 102a, 102b of the rear axle brake circuit 104 can be vented via the relay valve 39. In the embodiments shown, the first relay valve 39 vents the first working port 11 provided that the first relay valve control port 39.4 is also vented. The outlet valve 29 is here provided for venting the first relay valve control port 39.4. A first outlet valve port 29.1, which is also called an outlet valve inlet port 29.1, is likewise connected to the control line 35 and thus also to the first relay valve control port 39.4. Here, the outlet valve 29 is configured as an electronically switchable 2/2-way valve, namely as a solenoid valve. A second outlet valve port 29.2, which is also called an outlet valve outlet port 29.2, is connected to the vent 43. In the switching position shown in FIG. 2, into which the outlet valve 29 is pretensioned, the outlet valve 29 is closed and the first outlet valve port 29.1 and the second outlet valve port 29.2 are separated. If the control line 35 or the relay valve control port 39.4 is now to be vented, the outlet valve 29 is brought into an open switching position in which the first outlet valve port 29.1 and the second outlet valve port 29.2 are fluidically connected. For this purpose, the first electronic control unit 19 provides corresponding second control signals S2 at the first outlet valve 29. The first control line 35 is then indirectly connected to the vent 43 via the outlet valve 29.

The function mode of the second channel 9 is substantially similar in normal operation, so that reference is made in this regard to the description of the first channel 7. In normal operation, the first electronic control unit 19 and the second electronic control unit 25 output the first brake pressure pB1 and the second brake pressure pB2 substantially independently of one another.

For the redundancy case, if one of the electronic control units 19, 25 has a fault, the multi-channel brake pressure modulator 1 includes an additional redundancy. A redundancy circuit 45 is provided to provide this redundancy. The embodiments of the present disclosure differ substantially in the configuration of their respective redundancy circuits 45, wherein these differences are discussed further below. In the first embodiment of the multi-channel brake pressure modulator 1 illustrated in FIG. 2, the redundancy circuit 45 connects the first control line 35 of the first channel 7 to the second control line 37 of the second channel 37. This connection is not made directly here, but via a first redundancy valve 47 and a second redundancy valve 49. The redundancy valves 47, 49 of the redundancy circuit 45 are electronically controllable redundancy valves 47, 49, wherein the first redundancy valve 47 is controlled by the first electronic control unit 19 and wherein the second redundancy valve 49 is controlled by the second electronic control unit 25. In the first embodiment, the redundancy valves 47, 49 are each configured as 2/2-way valves. The first redundancy valve 47 is pretensioned into the open switching position shown in FIG. 2, so that it is open in the de-energized state and fluidically connects a redundancy line 51 to the first control line 35. By corresponding third control signals S3 of the first electronic control unit 19, the first redundancy valve 47 can be switched to a closed switching position, in which the first redundancy valve 47 interrupts a fluidic connection between the first control line 35 and the redundancy line 51.

The second redundancy valve 49 here is also pretensioned into an open switching position. It can be switched into a closed switching position via fourth control signals S4 of the second electronic control unit 25. In the open switching position, the second redundancy valve 49 fluidically connects the second control line 37 of the second channel 9 to the redundancy line 51. In the closed switching position however, the second redundancy valve 49 interrupts the connection between the second control line 37 and the redundancy line 51. So if, in the first embodiment of the multi-channel brake pressure modulator 1, both the first redundancy valve 47 and also the second redundancy valve 49 are in the respective open switching position, then the redundancy circuit 51 connects the first control line 35 of the first channel 7 to the second control line 37 of the second channel 9. In normal operation, the first electronic control unit 19 provides the third control signals S3, and/or the second electronic control unit 25 provides the fourth control signals S4, in order to interrupt the connection of the control lines 35, 37.

If the second electronic control unit 25 now has a fault, for example because a voltage supply of the second electronic control unit 25 is interrupted, a redundancy case exists. In the first embodiment, the second inlet valve 31 is pretensioned into the open switching position shown in FIG. 2 and thus prevents provision of the second control pressure pS2 through the second inlet valve 31 at the second relay valve 41. Since the second electronic control unit 25 also does not provide fourth control signals S4 in this redundancy case, the second redundancy valve 49 switches into the open switching state and connects the second control line 37 to the redundancy line 51. If a deceleration of the vehicle 200 is now requested by a human driver or by the autonomous unit 119, the first electronic control unit 19, which is still functional in this example, provides the first control signals S1, such that the first control pressure pS1, corresponding to the first control signals S1, is output in the first control line 35. In addition, in the redundancy case, the first electronic control unit 19 does not provide third control signals S3, so that the first redundancy valve 47 transfers into the open switching position shown in FIG. 2. The first control line 35 is then connected to the second control line 37 via the first redundancy valve 47, the redundancy line 51 and the second redundancy valve 49. The first control pressure pS1 of the first channel 7 can thus also be provided as control pressure for the second main valve unit 23 or the second relay valve 41 of the second channel 9. The purely pneumatically operating second relay valve 41 can thus, in the redundancy case, provide a second brake pressure pB2, which corresponds to the first control pressure pS1 of the first pilot control unit 15, at the second working port 13.

Conversely, if the first electronic control unit 19 has a fault and the second electronic control unit 25 is functional, the second control pressure pS2, provided by the second pilot control unit 21 or the second inlet valve 31 of the second pilot control unit 21, can similarly be used as control pressure of the second relay valve 41 and as control pressure of the first relay valve 39 of the first channel 7. The electropneumatic multi-channel brake pressure modulator 1 thus still allows electronic control of the first brake pressure pB1 and of the second brake pressure pB2 even in the event of failure of one of the two electronic control units 19, 25.

In the first embodiment (FIG. 2), a further redundancy is also provided. If necessary, the redundancy pressure pR provided at the redundancy port 5 can also be used as control pressure for the first main valve arrangement 17 and/or the second main valve arrangement 23. In the second embodiment, the use of the redundancy pressure pR as control pressure is provided in particular for the case in which both the first electronic control unit 19 and the second electronic control unit 25 have a fault. If, for example, the first electronic control unit 19 and the second electronic control unit 25 are de-energized, the first inlet valve 27 and the second inlet valve 31 are closed and do not provide a first control pressure pS1 or a second control pressure pS2. In the above-described manner, the first and second redundancy valves 47, 49 are open and connect the first control line 35 to the second control line 37.

The redundancy port 5 is fluidically connected to the first redundancy valve 47 and the redundancy line 51, such that the redundancy pressure pR is present as control pressure at the first main valve arrangement 17 and the second main valve arrangement 23. In the embodiment shown, the redundancy port 5 is only indirectly connected to the first redundancy valve 47 and the second redundancy valve 49. Thus, in the first embodiment of the multi-channel brake pressure modulator 1, a first holding valve 53 and a second holding valve 55 are provided between the redundancy port 5 and the redundancy valves 47, 49. The holding valves 53, 55 are preferably of identical configuration. Here, the first holding valve 53 and the second holding valve 55 are each configured as an electronically switchable 2/2-way valve. The holding valves 53, 55 are pretensioned into the open switching position shown in FIG. 2, so that they are open in the de-energized state and allow the fluidic connection of the reservoir port 5 to the first redundancy valve 47 or the second redundancy valve 49.

The first holding valve 53 is controlled by the first electronic control unit 19. The first electronic control unit 19 is configured to provide fifth control signals S5 at the first holding valve 53 in order to switch it into a closed switching position and thus interrupt the fluidic connection between the redundancy port 5 and the redundancy valves 47, 49. In this way it can be achieved, for example, that the redundancy pressure pR is used as control pressure of the first main valve arrangement 17 and the second main valve arrangement 37 only if both the first electronic control unit 19 and also the second electronic control unit 25 have a fault. As long as the first electronic control unit 19 is still functional, however, it can interrupt the connection between the control lines 35, 37 and the redundancy port 5 by providing corresponding fifth control signals S5 (and closing the first holding valve 53). Similarly, the second electronic control unit 25 is connected to the second holding valve 55 for providing sixth control signals S6.

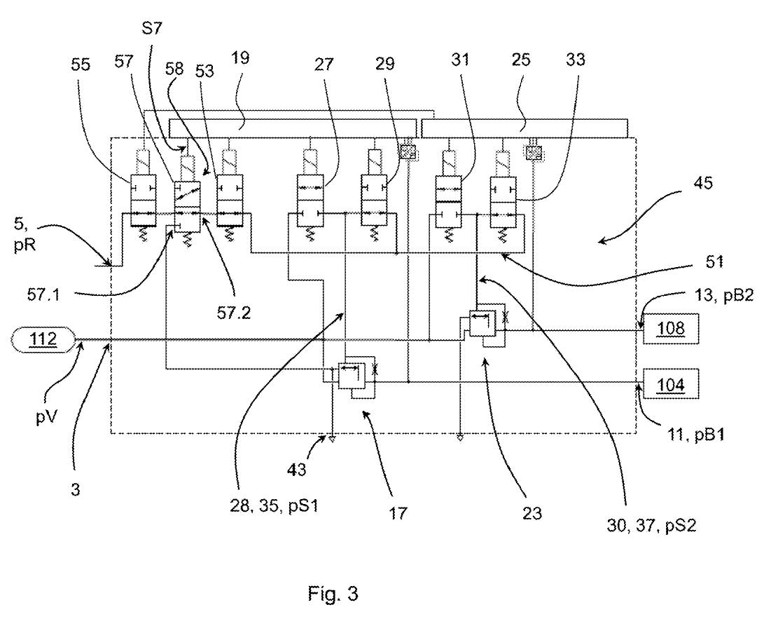

FIG. 3 now shows schematically a second preferred embodiment of the multi-channel brake pressure modulator 1, wherein substantially the differences from the multi-channel brake pressure modulator 1 according to the first embodiment are discussed below. In the second embodiment of the multi-channel brake pressure modulator 1, the redundancy line 51 of the redundancy circuit 45 directly connects the first outlet valve 29 and the second outlet valve 33 to one another. For a redundancy case in which one of the electronic control units 19, 25 continues to be functional, the first control line 35 is connected to the second control line 37 via the first outlet valve 29, the redundancy line 51 and the second outlet valve 33. In the second embodiment too, the first control pressure pS1 can thus also be used as control pressure pS of the second main valve arrangement 23, and/or the second control pressure pS2 can be used as control pressure pS of the first main valve arrangement 17. In a similar fashion to the multi-channel brake pressure modulator 1 of the first embodiment, in the multi-channel brake pressure modulator 1 according to the second embodiment, two holding valves 53, 55 are also provided which can establish or block an (indirect) connection of the redundancy port 5 to the control lines 35, 37.

In the second embodiment of the multi-channel brake pressure modulator 1, no redundancy valves 47, 49 are provided, since the outlet valves 29, 33 are directly connected. In order nonetheless to permit venting of the control lines 35, 37, a venting valve 57 is provided. Here, the venting valve 57 is arranged between the first holding valve 53 and the second holding valve 55. However, it may also be provided that the venting valve 57 is arranged between the redundancy port 5 and one of the holding valves 53, 55, or that both holding valves 53, 55 are arranged between the redundancy port 5 and the venting valve 57.

The venting valve 57 is here an electronically switchable 3/2-way valve. In the switching position shown in FIG. 3, the venting valve 57 fluidically connects the two holding valves 53, 55 to one another. The venting valve is preferably pretensioned into this redundancy switching position. In the second embodiment, the first electronic control unit 19 is provided for controlling the venting valve 57. However, it may also be provided that the second electronic control unit 25 controls the venting valve 57. As a result of the pretensioning into the redundancy switching position, the redundancy port 5 is connected to the redundancy line 51 in the event of a fault in both electronic control units 19, 25, and the redundancy pressure pR can be used as control pressure for the first main valve arrangement 17 and the second main valve arrangement 23.

By providing corresponding seventh control signals S7, the venting valve 57 can be switched into a venting position 58. In this venting position 58, a first venting valve port 57.1 is fluidically connected to a second venting valve port 57.2. The first venting valve port 57.1 is connected to the vent 43, while the second venting valve port 57.2 is connected to the first holding valve 53. When the venting valve 57 is in the venting position 58, the first control line 35 can be vented via the first outlet valve 29 and the first holding valve 53. For this purpose, in the second embodiment shown, the first electronic control unit 19 then provides the seventh control signals S7 for the venting valve 57. At the same time, the first electronic control unit 19 does not provide second control signals S2, so that the outlet valve 29 is open. The second control line 37 of the second channel 35 can be vented by corresponding switching of the second outlet valve 39 of the first holding valve 53 and of the venting valve 57. In the event of a fault in both control units 19, 25, the control lines 35, 37 can be vented via the redundancy port 5. For example, the venting can then take place via the brake transducer 118 connected to the redundancy port 5.

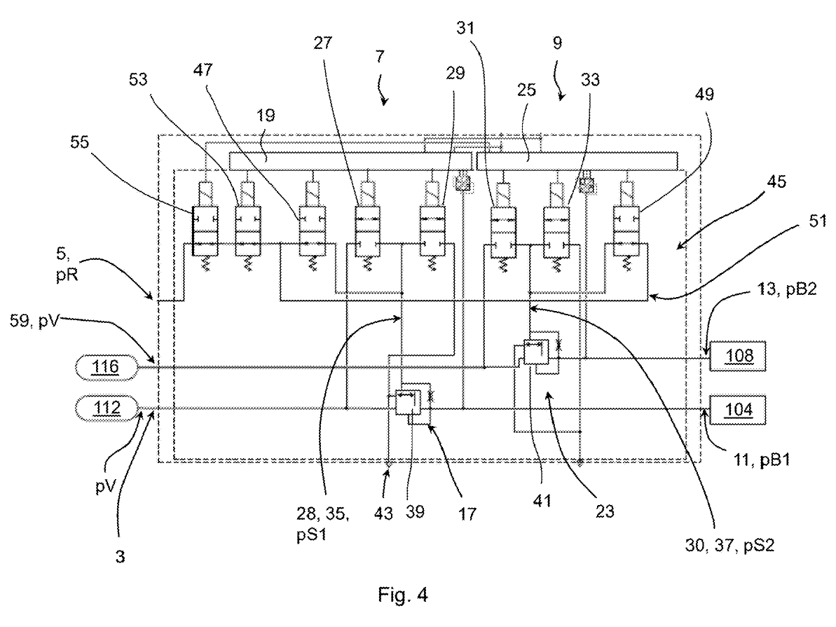

FIG. 4 now show schematically a third preferred embodiment of the multi-channel brake pressure modulator 1. The function method of the multi-channel brake pressure modulator 1 according to the third example is substantially similar to the function method of the multi-channel brake pressure modulator 1 according to the first embodiment. One difference is that, in the third embodiment, a second reservoir port 59 is provided which is connected to the second compressed air reservoir 116. In this embodiment, the first compressed air reservoir 112 thus provides reservoir pressure pV for the first channel 7 via the reservoir port 3. In contrast to the first embodiment of the multi-channel brake pressure modulator 1, in the embodiment according to FIG. 4, the second channel 9 is however supplied with reservoir pressure pV from the second compressed air reservoir 116 and via the second reservoir port 59. The use of second compressed air reservoirs 112, 116 can make the system more fail-safe and/or its integration into the brake system 100 more flexible.

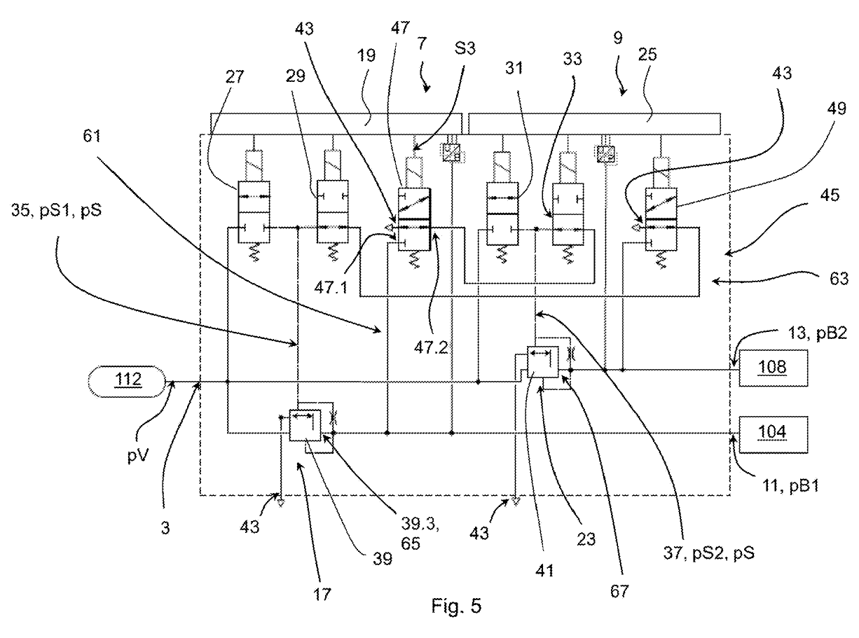

FIG. 5 now shows schematically a fourth preferred embodiment of the multi-channel brake pressure modulator 1. In this embodiment of the multi-channel brake pressure modulator 1, no redundancy port 5 is provided. Therefore also no holding valves 53, 55 are provided in the fourth embodiment. However, it should be understood that a redundancy port 5 could also be provided in the fourth embodiment. The function of the first channel 7 and of the second channel 9 in normal operation is substantially similar to that explained above with reference to the first embodiment.

In the multi-channel brake pressure modulator 1 according to FIG. 5, in the redundancy case, a brake pressure pB1, pB2 is provided as control pressure pS for the first main valve arrangement 17 or the second main valve arrangement 23 respectively. In the fourth embodiment of the multi-channel brake pressure modulator 1, the redundancy circuit 45 therefore does not connect the two control lines 35, 37.

In the fourth embodiment of the multi-channel brake pressure modulator 1, the redundancy circuit 51 includes two redundancy sub-circuits 61, 63. However, in other variants, also only one of the redundancy sub-circuits 61, 63 may be provided. A first redundancy sub-circuit 61 connects a first brake pressure port 65, which - in the embodiment according to FIG. 5 and preferably - corresponds to the relay valve working port 39.4, to the second control line 37. The first brake pressure pB1 output at the first relay valve 39 can therefore be provided as control pressure pS for the second channel 9 or its second main valve arrangement 23. Similarly, the second redundancy sub-circuit 63 connects a second brake pressure port 67 to the first control line 35. The second brake pressure port 67 is a working port of the second relay valve 41, so that in the redundancy case, the second brake pressure pB2 can be provided as control pressure pS for the first main valve arrangement 17. In the fourth embodiment, the first redundancy sub-circuit 61 includes the first redundancy valve 47, and the second redundancy sub-circuit 63 includes the second redundancy valve 49. The first redundancy valve 47 can be controlled by the first electronic control unit 19 and the second redundancy valve 49 can be controlled by the second electronic control unit 25. Here, the redundancy valves 47, 49 are configured substantially identically.

In contrast to the first embodiment, the redundancy valves 47, 49 are not configured as 2/2-way valves, but as 3/2-way valves. The first redundancy valve 47 has a redundancy switching position and a venting position, wherein the venting position is shown in FIG. 5. In the venting position, the first redundancy valve 47 connects the second outlet valve 33 of the second channel 9 to a vent 43. For the sake of simplicity, FIG. 5 shows a total of four vents 43. However, it should be understood that the multi-channel brake pressure modulator 1 can also have only one, two, three or more than four vents 43. In the venting position 43, into which the first redundancy valve 47 is preferably pretensioned, the redundancy valve 47 together with the second outlet valve thus allows venting of the second control line 37.

In the event of a fault in the second electronic control unit 25, the second outlet valve 33 opens automatically since, in this embodiment (FIG. 5), it is pretensioned into the open switching position. The first electronic control unit 19 (which is functional in this example) provides the third control signals S3 at the first redundancy valve 47 if necessary, and thus switches the latter from the venting position into the redundancy switching position. In the redundancy switching position, a first redundancy valve port 47.1 of the first redundancy valve 47 is fluidically connected to a second redundancy valve port 47.2 of the first redundancy valve 47. The first redundancy valve port 47.1 is connected to the first brake pressure port 65. The first redundancy sub-circuit 61 thus allows the first brake pressure pB1 to be provided via the first redundancy valve port 47.1, the second redundancy valve port 47.2 and the second outlet valve 33, at the control line 37 or a control port of the second main valve arrangement 23. Similarly, the second redundancy sub-circuit 63 allows the provision of the second brake pressure pB2, output at the second brake pressure port 67, as control pressure pS for the first main valve arrangement 17.

It is understood that the foregoing description is that of the preferred embodiments of the invention and that various changes and modifications may be made thereto without departing from the spirit and scope of the invention as defined in the appended claims.

### REFERENCE SIGNS PART OF THE DESCRIPTION

1 Multi-channel brake pressure modulator
3 Reservoir port
5 Redundancy port
7 First channel
9 Second channel
11 First working port
13 Second working port
15 First pilot control unit
17 First main valve arrangement
19 First electronic control unit
21 Second pilot control unit
23 Second main valve arrangement
25 Second electronic control unit
27 First inlet valve 27.1 First inlet valve port
27.2 Second inlet valve port, inlet valve working port
28 First connection
29 First outlet valve
29.1 First outlet valve port, outlet valve inlet port
29.2 Second outlet valve port, outlet valve outlet port
30 Second connection
31 Second inlet valve
31.2 Second inlet valve working port
33 Second outlet valve
33.1 Second outlet valve inlet port
33.2 Second outlet valve outlet port
35 First control line
37 Second control line
39 First relay valve
39.1 Relay valve reservoir port
39.2 Relay valve venting port
39.3 Relay valve working port
39.4 Relay valve control port, first control port
41 Second relay valve
41.4 Relay valve control port, second control port
43 Vent
45 Redundancy circuit
47 First redundancy valve
47.1 First redundancy valve port
47.2 Second redundancy valve port
49 Second redundancy valve
51 Redundancy line
53 First holding valve
55 Second holding valve
57 Venting valve
57.1 First venting valve port
57.2 Second venting valve port
58 Venting position
59 Second reservoir port
61 First redundancy sub-circuit
63 Second redundancy sub-circuit
65 First brake pressure port
67 Second brake pressure port
100 Brake system
102a, 102b Rear axle brake actuators
104 Rear axle brake circuit, first brake circuit
106a, 106b Front axle brake actuators
108 Front axle brake circuit, second brake circuit
110 ABS valve
112 First compressed air reservoir
116 Second compressed air reservoir
118 Brake transducer
119 Autonomous unit
120 Brake signal line
122 Trailer brake circuit
124 Third compressed air reservoir
126 Trailer module
128 Trailer control line
200 Vehicle
202 Utility vehicle
ECU Main control unit
HA Rear axle
pB1 First brake pressure
pB2 Second brake pressure
pBHA Rear axle brake pressure
pBVA Front axle brake pressure
pR Redundancy pressure
pV Reservoir pressure
S1, S2, S3, S4, S5, S6, S7 Control signals
SB Brake signal
ST Trailer control signal
VA Front axle

1. An electropneumatic multi-channel brake pressure modulator for a utility vehicle, the electropneumatic multi-channel brake pressure modulator comprising:
at least one first reservoir port for connecting a first compressed air reservoir for providing reservoir pressure at said at least one first reservoir port;
a first channel including a first working port, a first electropneumatic pilot control unit, and a first main valve arrangement;
a second channel including a second working port, a second electropneumatic pilot control unit, and a second main valve arrangement;
a first electronic control unit for controlling said first electropneumatic pilot control unit;
a second electronic control unit for controlling said second electropneumatic pilot control unit;
said first electropneumatic pilot control unit being configured to receive the reservoir pressure from said at least one first reservoir port and to provide a first control pressure as a function of first control signals which are provided by said first electronic control unit at said first electropneumatic pilot control unit;
said second electropneumatic pilot control unit being configured to receive the reservoir pressure from said at least one reservoir port and to provide a second control pressure as a function of second control signals which are provided by said second electronic control unit at said second electropneumatic pilot control unit;
said first main valve arrangement being configured to receive the first control pressure and to provide a volume-amplified first brake pressure, corresponding to the received first control pressure, at said first working port;
said second main valve arrangement being configured to receive the second control pressure and to provide a volume-amplified second brake pressure, corresponding to the received second control pressure, at said second working port;
a first connection connecting said first pilot control unit to said first main valve arrangement for providing the first control pressure being free of selectively switchable elements;
a second connection connecting said second pilot control unit to said second main valve arrangement for providing the second control pressure being free of selectively switchable elements; and,
a redundancy circuit for providing at least one of:
a first pressure of said first channel as a control pressure for said second main valve arrangement for output of the second brake pressure in a redundancy case; and,
a second pressure of said second channel as a control pressure for said first main valve arrangement for output of the first brake pressure in the redundancy case.

2. The electropneumatic multi-channel brake pressure modulator of claim 1, wherein said first pilot control unit of said first channel has a first inlet valve for output of the first control pressure and a first outlet valve; and, said second pilot control unit of said second channel has a second inlet valve for output of the second control pressure and a second outlet valve.

3. The electropneumatic multi-channel brake pressure modulator of claim 2, wherein at least one of:
said redundancy circuit connects said first pilot control unit of said first channel at least indirectly to said second main valve arrangement for providing the first control pressure at said second main valve arrangement; and,
said redundancy circuit connects said second pilot control unit of said second channel at least indirectly to said first main valve arrangement for providing the second control pressure at said first main valve arrangement.

4. The electropneumatic multi-channel brake pressure modulator of claim 3, wherein said first channel has a first control line which connects said first pilot control unit to said first main valve arrangement; said second channel has a second control line which connects said second pilot control unit to said second main valve arrangement; and, said redundancy circuit connects said first control line to said second control line.

5. The electropneumatic multi-channel brake pressure modulator of claim 4, wherein said redundancy circuit has a first redundancy valve; and, said redundancy circuit indirectly connects said first control line to said second control line via said first redundancy valve.

6. The electropneumatic multi-channel brake pressure modulator of claim 5, wherein said redundancy circuit further includes a second redundancy valve between said first control line and said second control line.

7. The electropneumatic multi-channel brake pressure modulator of claim 6, wherein said first redundancy valve is an electronically switchable redundancy valve and said second redundancy valve is an electronically switchable redundancy valve; said first electronic control unit is configured to control said first redundancy valve; and, said second electronic control unit is configured to control said second redundancy valve.

8. The electropneumatic multi-channel brake pressure modulator of claim 3, wherein said first outlet valve of said first pilot control unit has a first outlet valve inlet port, which is connected to a first inlet valve working port of said first inlet valve, and a first outlet valve outlet port;
said second outlet valve of the second pilot control unit has a second outlet valve inlet port, which is connected to a second inlet valve working port of said second inlet valve, and a second outlet valve outlet port; and,
said redundancy circuit connects said first outlet valve outlet port of said first outlet valve of said first channel to said second outlet valve outlet port of said second outlet valve of said second channel.

9. The electropneumatic multi-channel brake pressure modulator of claim 8 further comprising:
a switchable venting valve having a venting position;
wherein at least one of:
said switchable venting valve is connected to said first outlet valve outlet port of said first outlet valve and, in said venting position, connects said first outlet valve outlet port to a vent of the electropneumatic multi-channel brake modulator; and,
said switchable venting valve is connected to said second outlet valve outlet port of said second outlet valve, and in said venting position, connects said second outlet valve outlet port to said vent of the electropneumatic multi-channel brake modulator.

10. The electropneumatic multi-channel brake pressure modulator of claim 1 further comprising a redundancy port for providing a redundancy pressure.

11. The electropneumatic multi-channel brake pressure modulator of claim 10, wherein at least one of:
the redundancy pressure is configured to be output as a control pressure at said first main valve arrangement when said first electronic control unit has a first fault; and,
the redundancy pressure is configured to be output as a control pressure at said second main valve arrangement when said second electronic control unit has a second fault.

12. The electropneumatic multi-channel brake pressure modulator of claim 10 further comprising:
a first electronically controllable holding valve;
a second electronically controllable holding valve; and,
wherein said first electronically controllable holding valve and said second electronically controllable holding valve connect said redundancy port to said redundancy circuit.

13. The electropneumatic multi-channel brake pressure modulator of claim 12, wherein at least one of:
said first electronic control unit is configured to control said first electronically controllable holding valve; and,
said second electronic control unit is configured to control said second electronically controllable holding valve.

14. The electropneumatic multi-channel brake pressure modulator of claim 2, wherein at least one of:
said redundancy circuit connects a first brake pressure port of said first main valve arrangement at least indirectly to a second control port of said second main valve arrangement, in order to be able to provide the first brake pressure as a control pressure at said second main valve arrangement; said redundancy circuit connects said first brake pressure port to said second control port; and,
said redundancy circuit connects a second brake pressure port of said second main valve arrangement at least indirectly to a first control port of said first main valve arrangement, in order to be able to provide the second brake pressure as a control pressure at said first main valve arrangement, wherein said redundancy circuit connects said second brake pressure port to said first control port.

15. The electropneumatic multi-channel brake pressure modulator of claim 14, wherein at least one of:
said redundancy circuit connects said first brake pressure port, via a second outlet valve of said second channel, to said second control port; and,
said redundancy circuit connects said second brake pressure port, via a first outlet valve of said first channel, to said first control port.

16. A brake system for a utility vehicle comprising:
a first brake circuit;
a second brake circuit;
an electropneumatic multi-channel brake modulator including at least one first reservoir port for connecting a first compressed air reservoir for providing reservoir pressure at said at least one first reservoir port;
said an electropneumatic multi-channel brake modulator further including a first channel, a second channel, a first electronic control unit, a second electronic control unit, a first connection, a second connection, and a redundancy circuit;
said first channel including a first working port, a first electropneumatic pilot control unit, and a first main valve arrangement;
said second channel including a second working port, a second electropneumatic pilot control unit, and a second main valve arrangement;
said first electronic control unit being configured to control said first electropneumatic pilot control unit;
said second electronic control unit being configured to control said second electropneumatic pilot control unit;
said first electropneumatic pilot control unit being configured to receive the reservoir pressure from said at least one first reservoir port and to provide a first control pressure as a function of first control signals which are provided by said first electronic control unit at said first electropneumatic pilot control unit;
said second electropneumatic pilot control unit being configured to receive the reservoir pressure from said at least one reservoir port and to provide a second control pressure as a function of second control signals which are provided by said second electronic control unit at said second electropneumatic pilot control unit;
said first main valve arrangement being configured to receive the first control pressure and to provide a volume-amplified first brake pressure, corresponding to the received first control pressure, at said first working port;
said second main valve arrangement being configured to receive the second control pressure and to provide a volume-amplified second brake pressure, corresponding to the received second control pressure, at said second working port;
said first connection connecting said first pilot control unit to said first main valve arrangement for providing the first control pressure being free of selectively switchable elements;
said second connection connecting said second pilot control unit to said second main valve arrangement for providing the second control pressure being free of selectively switchable elements;
said redundancy circuit being configured to provide at least one of:
a first pressure of said first channel as a control pressure for said second main valve arrangement for output of the second brake pressure in a redundancy case, and,
a second pressure of said second channel as a control pressure for said first main valve arrangement for output of the first brake pressure in the redundancy case;
said first working port of said first channel of said multi-channel brake modulator being connected to said first brake circuit for providing the first brake pressure; and,
said second working port of said second channel of said multi-channel brake modulator being connected to said second brake circuit for providing the second brake pressure.

17. The brake system of claim 16 further comprising:
a first voltage supply for supplying said first electronic control unit with electrical energy; and,
a second voltage supply for supplying said second electronic control unit with electrical energy.

18. The brake system of claim 17, wherein said first voltage supply and said second voltage supply are operable independently of each other.

19. The brake system of claim 16 further comprising:
an autonomous unit;
a first bus system connected to said autonomous unit;
a second bus system connected to said autonomous unit;
said first electronic control unit of said multi-channel brake modulator being connected to said first bus system for providing and/or receiving signals; and,
said second electronic control unit of said multi-channel brake modulator being connected to said second bus system for providing and/or receiving signals.

20. The brake system of claim 19, wherein at least one of:
said first bus system is a first CAN bus; and,
said second bus system is a second CAN bus.

21. A utility vehicle comprising:
a brake system including a first brake circuit, a second brake circuit, and an electropneumatic multi-channel brake modulator;
said electropneumatic multi-channel brake modulator including at least one first reservoir port for connecting a first compressed air reservoir for providing reservoir pressure at said at least one first reservoir port;
said an electropneumatic multi-channel brake modulator further including a first channel, a second channel, a first electronic control unit, a second electronic control unit, a first connection, a second connection, and a redundancy circuit;
said first channel including a first working port, a first electropneumatic pilot control unit, and a first main valve arrangement;
said second channel including a second working port, a second electropneumatic pilot control unit, and a second main valve arrangement;
said first electronic control unit being configured to control said first electropneumatic pilot control unit;
said second electronic control unit being configured to control said second electropneumatic pilot control unit;
said first electropneumatic pilot control unit being configured to receive the reservoir pressure from said at least one first reservoir port and to provide a first control pressure as a function of first control signals which are provided by said first electronic control unit at said first electropneumatic pilot control unit;
said second electropneumatic pilot control unit being configured to receive the reservoir pressure from said at least one reservoir port and to provide a second control pressure as a function of second control signals which are provided by said second electronic control unit at said second electropneumatic pilot control unit;
said first main valve arrangement being configured to receive the first control pressure and to provide a volume-amplified first brake pressure, corresponding to the received first control pressure, at said first working port;
said second main valve arrangement being configured to receive the second control pressure and to provide a volume-amplified second brake pressure, corresponding to the received second control pressure, at said second working port;
said first connection connecting said first pilot control unit to said first main valve arrangement for providing the first control pressure being free of selectively switchable elements;
said second connection connecting said second pilot control unit to said second main valve arrangement for providing the second control pressure being free of selectively switchable elements;
said redundancy circuit being configured to provide at least one of:
a first pressure of said first channel as a control pressure for said second main valve arrangement for output of the second brake pressure in a redundancy case, and,
a second pressure of said second channel as a control pressure for said first main valve arrangement for output of the first brake pressure in the redundancy case;
said first working port of said first channel of said multi-channel brake modulator being connected to said first brake circuit for providing the first brake pressure; and, said second working port of said second channel of said multi-channel brake modulator being connected to said second brake circuit for providing the second brake pressure.
